(19) United States
(12) Patent Application Publication
(10) Pub. No.: US 2026/0057352 A1
(43) Pub. Date: Feb. 26, 2026

(54) INVENTORY AND DEVICE MANAGEMENT

(71) Applicant: Rockwell Automation Technologies, Inc., Mayfield Heights, OH (US)

(72) Inventors: James Binckly, Lindsay (CA); Stuart Fergusson, Toronto (CA); Gourav Jamwal, Abbotsford (CA); Katrina R. Rempel, Toronto (CA)

(21) Appl. No.: 18/811,412

(22) Filed: Aug. 21, 2024

(51) Int. Cl. G06Q 10/20; G06Q 10/0635; G06Q 10/087; G06Q 10/1093

(52) U.S. Cl. CPC G06Q 10/20; G06Q 10/0635; G06Q 10/087; G06Q 10/1097

(57) ABSTRACT

A work order management system automates the process of scheduling maintenance tasks and generating corresponding work orders via analysis of monitored data generated by the industrial assets. The work order management system can monitor control, status, or operational data from industrial devices on the plant floor, and initiate creation of work orders based on a determination that the monitored industrial data indicates a current or predicted performance risk requiring investigation or maintenance. To assist in automated maintenance scheduling, the system can automatically discover and register industrial assets and devices deployed in in the customer's facility. The system can register these assets using asset profiles that define maintenance knowledge for the respective assets. The system uses asset-specific knowledge encoded in the asset profiles to identify asset risk conditions and schedule corresponding maintenance countermeasures.

### BACKGROUND

The subject matter disclosed herein relates generally to industrial maintenance, and, more specifically, to industrial asset management and asset maintenance.

### BRIEF DESCRIPTION

The following presents a simplified summary in order to provide a basic understanding of some aspects described herein. This summary is not an extensive overview nor is it intended to identify key/critical elements or to delineate the scope of the various aspects described herein. Its sole purpose is to present some concepts in a simplified form as a prelude to the more detailed description that is presented later.

In one or more embodiments, a system is provided, comprising a memory that stores executable components and a library of asset profile templates corresponding to respective types of industrial assets; and a processor, operatively coupled to the memory, that executes the executable components, the executable components comprising: a monitoring component configured to monitor industrial asset data generated by industrial assets in service within an industrial facility, wherein the industrial asset data comprises operational and status information for the industrial assets; a device management component configured to, in response to discovery, based on analysis of the industrial asset data, of an industrial asset that is not registered with the system, retrieve, from the library of asset profile templates, an asset profile template corresponding to a type of the industrial asset, customize the asset profile template using configuration information obtained from the industrial asset to yield an asset profile for the industrial asset, and record the asset profile with other asset profiles corresponding to other industrial assets in service within the industrial facility to yield asset management data; and a work order generation component configured to generate work orders for maintenance to be performed on the industrial assets based on the asset management data.

Also, one or more embodiments provide a method, comprising monitoring, by a system comprising a processor, industrial asset data generated by industrial assets in service within an industrial facility, wherein the industrial asset data comprises operational and status information for the industrial assets; in response to discovering, based on analysis of the industrial asset data, an industrial asset that is not registered with the system: retrieving, by the system from a library of asset profile templates, an asset profile template corresponding to a type of the industrial asset, wherein the asset profile templates correspond to respective types of industrial assets; customizing, by the system, the asset profile template using configuration information obtained from the industrial asset to yield an asset profile for the industrial asset; and recording, by the system, the asset profile with other asset profiles corresponding to other industrial assets in service within the industrial facility to yield asset management data; and generating, by the system, work orders for maintenance to be performed on the industrial assets based on the asset management data.

Also, according to one or more embodiments, a non-transitory computer-readable medium is provided having stored thereon instructions that, in response to execution, cause a system to perform operations, the operations comprising monitoring industrial asset data generated by industrial assets in service within an industrial facility, wherein the industrial asset data comprises operational and status information for the industrial assets; in response to discovering, based on analysis of the industrial asset data, an industrial asset that is not registered with the system: retrieving, from a library of asset profile templates, an asset profile template corresponding to a type of the industrial asset, wherein the asset profile templates correspond to respective types of industrial assets; customizing the asset profile template using configuration information obtained from the industrial asset to yield an asset profile for the industrial asset; and recording the asset profile with other asset profiles corresponding to other industrial assets in service within the industrial facility to yield asset management data; and generating work orders for maintenance to be performed on the industrial assets based on the asset management data.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment.

FIG. 2 is a block diagram of a work order management system.

FIG. 3 is a diagram illustrating generation of work orders using the work order management system.

FIG. 4 is a diagram illustrating an example architecture for automatically generating work orders based on analysis of real-time or historical industrial asset performance.

FIG. 5 is an example work order display that can be rendered on a client device by the work order management system.

FIG. 6 is another example view of the work order display in which individual maintenance tasks defined by the work order are rendered as a formatted list.

FIG. 7 is a block diagram illustrating the use of a discovery agent by the work order management system to discover and register industrial assets and devices.

FIG. 8 is a diagram illustrating an example approach for creating an asset profile.

FIG. 9 is a diagram illustrating a general architecture for providing maintenance recommendations and guidance to customers using customer-specific asset management data.

FIG. 10 is a diagram illustrating generation and delivery of an asset management dashboard to a client device.

FIG. 11 is a diagram illustrating remote configuration of a customer's industrial assets using work order management system.

FIG. 12 is a diagram illustrating an example architecture for tracking inventories of parts and devices.

FIG. 13 is a flowchart an example methodology for automatically identifying and recording industrial assets in operation within an industrial facility.

FIG. 14 is a flowchart of a first part of an example methodology for dynamically generating and scheduling work orders using asset management data maintained by a work order management system.

FIG. 15 is an example computing environment.

FIG. 16 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

Industrial controllers, their associated I/O devices, motor drives, and other such industrial devices are central to the operation of modern automation systems. Industrial controllers interact with field devices on the plant floor to control automated processes relating to such objectives as product manufacture, material handling, batch processing, supervisory control, and other such applications.

Industrial controllers store and execute user-defined control programs to effect decision-making in connection with the controlled process. Such programs can include, but are not limited to, ladder logic, sequential function charts, function block diagrams, structured text, or other such platforms.

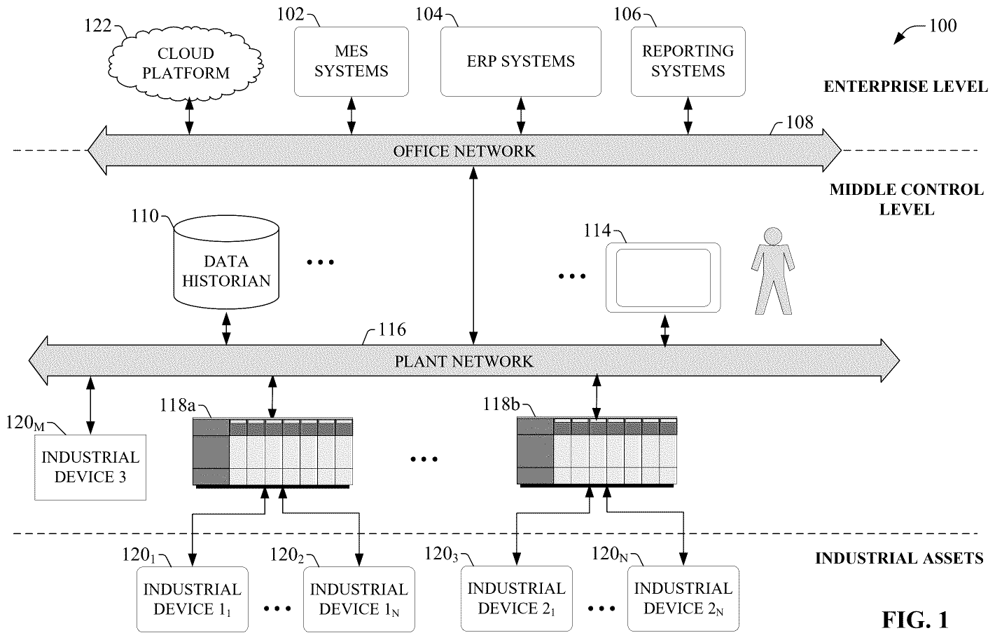

FIG. 1 is a block diagram of an example industrial control environment 100. In this example, a number of industrial controllers 118 are deployed throughout an industrial plant environment to monitor and control respective industrial systems or processes relating to product manufacture, machining, motion control, batch processing, material handling, or other such industrial functions. Industrial controllers 118 typically execute respective control programs to facilitate monitoring and control of industrial devices 120 making up the controlled industrial assets or systems (e.g., industrial machines). One or more industrial controllers 118 may also comprise a soft controller executed on a personal computer or other hardware platform, or on a cloud platform. Some hybrid devices may also combine controller functionality with other functions (e.g., visualization). The control programs executed by industrial controllers 118 can comprise any conceivable type of code used to process input signals read from the industrial devices 120 and to control output signals generated by the industrial controllers, including but not limited to ladder logic, sequential function charts, function block diagrams, or structured text.

Industrial devices 120 may include both input devices that provide data relating to the controlled industrial systems to the industrial controllers 118, and output devices that respond to control signals generated by the industrial controllers 118 to control aspects of the industrial systems. Example input devices can include telemetry devices (e.g., temperature sensors, flow meters, level sensors, pressure sensors, etc.), manual operator control devices (e.g., push buttons, selector switches, etc.), safety monitoring devices (e.g., safety mats, safety pull cords, light curtains, etc.), and other such devices. Output devices may include motor drives, pneumatic actuators, signaling devices, robot control inputs, valves, and the like. Some industrial devices, such as industrial device 120_{M}, may operate autonomously on the plant network 116 without being controlled by an industrial controller 118.

Industrial controllers 118 may communicatively interface with industrial devices 120 over hardwired or networked connections. For example, industrial controllers 118 can be equipped with native hardwired inputs and outputs that communicate with the industrial devices 120 to effect control of the devices. The native controller I/O can include digital I/O that transmits and receives discrete voltage signals to and from the field devices, or analog I/O that transmits and receives analog voltage or current signals to and from the devices. The controller I/O can communicate with a controller's processor over a backplane such that the digital and analog signals can be read into and controlled by the control programs. Industrial controllers 118 can also communicate with industrial devices 120 over the plant network 116 using, for example, a communication module or an integrated networking port. Exemplary networks can include the Internet, intranets, Ethernet, DeviceNet, ControlNet, Data Highway and Data Highway Plus (DH/DH+), Remote I/O, Fieldbus, Modbus, Profibus, wireless networks, serial protocols, and the like. The industrial controllers 118 can also store persisted data values that can be referenced by the control program and used for control decisions, including but not limited to measured or calculated values representing operational states of a controlled machine or process (e.g., tank levels, positions, alarms, etc.) or captured time series data that is collected during operation of the automation system (e.g., status information for multiple points in time, diagnostic occurrences, etc.). Similarly, some intelligent devices - including but not limited to motor drives, instruments, or condition monitoring modules - may store data values that are used for control and/or to visualize states of operation. Such devices may also capture time-series data or events on a log for later retrieval and viewing.

Industrial automation systems often include one or more human-machine interfaces (HMIs) 114 that allow plant personnel to view telemetry and status data associated with the automation systems, and to control some aspects of system operation. HMIs 114 may communicate with one or more of the industrial controllers 118 over a plant network 116, and exchange data with the industrial controllers to facilitate visualization of information relating to the controlled industrial processes on one or more pre-developed operator interface screens. HMIs 114 can also be configured to allow operators to submit data to specified data tags or memory addresses of the industrial controllers 118, thereby providing a means for operators to issue commands to the controlled systems (e.g., cycle start commands, device actuation commands, etc.), to modify setpoint values, etc. HMIs 114 can generate one or more display screens through which the operator interacts with the industrial controllers 118, and thereby with the controlled processes and/or systems. Example display screens can visualize present states of industrial systems or their associated devices using graphical representations of the processes that display metered or calculated values, employ color or position animations based on state, render alarm notifications, or employ other such techniques for presenting relevant data to the operator. Data presented in this manner is read from industrial controllers 118 by HMIs 114 and presented on one or more of the display screens according to display formats chosen by the HMI developer. HMIs may comprise fixed location or mobile devices with either user-installed or pre-installed operating systems, and either user-installed or pre-installed graphical application software.

Some industrial environments may also include other systems or devices relating to specific aspects of the controlled industrial systems. These may include, for example, one or more data historians 110 that aggregate and store production information collected from the industrial controllers 118 and other industrial devices.

Industrial devices 120, industrial controllers 118, HMIs 114, associated controlled industrial assets, and other plant-floor systems such as data historians 110, vision systems, and other such systems operate on the operational technology (OT) level of the industrial environment. Higher level analytic and reporting systems may operate at the higher enterprise level of the industrial environment in the information technology (IT) domain; e.g., on an office network 108 or on a cloud platform 122. These higher level systems can include, for example, enterprise resource planning (ERP) systems 104 that integrate and collectively manage high-level business operations, such as finance, sales, order management, marketing, human resources, or other such business functions. Manufacturing Execution Systems (MES) 102 can monitor and manage control operations on the control level in view of higher-level business considerations, driving those control-level operations toward outcomes that satisfy defined business goals (e.g., order fulfillment, resource tracking and management, asset utilization tracking, etc.). Reporting systems 106 can collect operational data from industrial devices on the plant floor and generate daily or shift reports that summarize operational statistics of the controlled industrial assets.

Industrial facilities typically house and operate many industrial assets, machines, or equipment. Many of these assets require regular proactive maintenance to ensure continued optimal operation, in addition to unplanned repair operations to address unexpected downtime events, such as machine malfunctions. To manage the large number of maintenance operations carried out at a given industrial enterprise, work order management systems can be used to initiate work orders for new maintenance operations to be performed and to track the statuses of these work orders. Maintenance technicians or managers can fill out and submit work orders for respective maintenance operations or tasks to the system. A work order typically remains open as its corresponding maintenance task is performed, and is then closed once the task is completed.

However, these work order management systems typically provide only crude status tracking capabilities for maintenance tasks, such as recording the open or closed statuses of work orders and other basic information about the maintenance tasks to be performed. These systems offer no dynamic maintenance guidance or planning assistance beyond basic descriptions of the maintenance tasks to be performed. Moreover, the large number of industrial assets and devices deployed within a given industrial facility renders the task of tracking and managing an industrial enterprise's assets prohibitively complicated.

To address these and other issues, one or more embodiments described herein provide a work order management system that supports intelligent maintenance scheduling and provides dynamic recommendations and guidance to assist with asset maintenance and management. In one or more embodiments, the work order management system includes asset management tools that can automatically discover, identify, and record an industrial customer's industrial assets and devices. The system can generate asset profiles for each discovered asset, which records the type of the asset as well as any customer-specific configurations for the respective assets. The system can also organize the asset profiles according to an asset hierarchy that defines relationships between the assets, as well as between primary assets and their sub-components. The system can use this collected and organized asset data to provide maintenance recommendations, software or configuration updates, backup and restore services, or other asset management services.

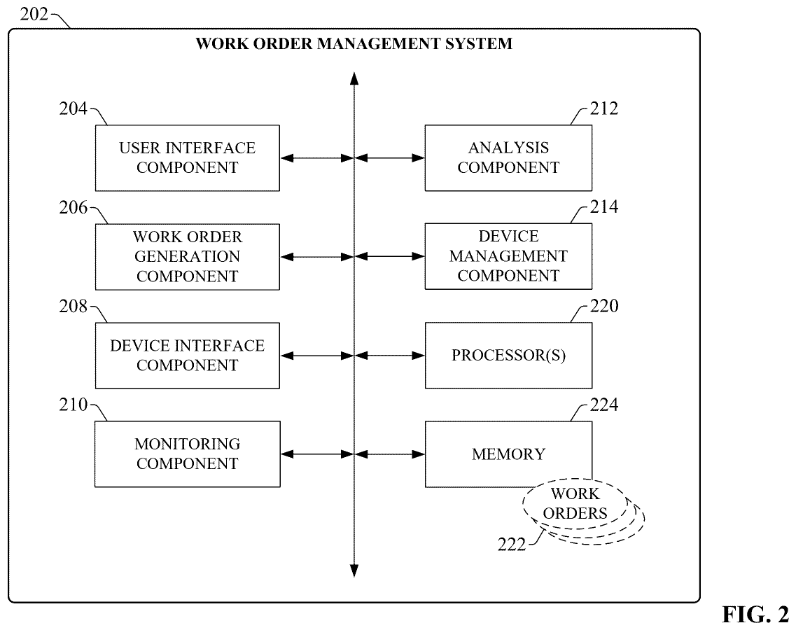

FIG. 2 is a block diagram of a work order management system 202 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Work order management system 202 can include a user interface component 204, a work order generation component 206, a device interface component 208, a monitoring component 210, an analysis component 212, a device management component 214, one or more processors 220, and memory 224. In various embodiments, one or more of the user interface component 204, work order generation component 206, device interface component 208, monitoring component 210, analysis component 212, device management component 214, the one or more processors 220, and memory 224 can be electrically and/or communicatively coupled to one another to perform one or more of the functions of the work order management system 202. In some embodiments, components 204, 206, 208, 210, 212, and 214 can comprise software instructions stored on memory 224 and executed by processor(s) 218. Work order management system 202 may also interact with other hardware and/or software components not depicted in FIG. 2. For example, processor(s) 220 may interact with one or more external user interface devices, such as a keyboard, a mouse, a display monitor, a touchscreen, or other such interface devices.

User interface component 204 can be configured to generate user interface displays that receive user input and render output to the user in any suitable format (e.g., visual, audio, tactile, etc.). In some embodiments, user interface component 204 can render these interface displays on a client device (e.g., a laptop computer, tablet computer, smart phone, etc.) that is communicatively connected to the work order management system 202 (e.g., via a hardwired or wireless connection). Input data that can be received via user interface component 204 can include, but is not limited to, work order data (e.g., work order data field entries), user interface navigation input, instructions to initiate device or asset management functions, or other such input data. Output data rendered by user interface component 204 can include, but is not limited to, information regarding closed and open work orders, maintenance recommendations or guidance, recommended workflows for performing a maintenance task defined by a work order, or other such output data.

Work order generation component 206 can be configured to generate work orders 222 based on user-submitted information about a maintenance task to be performed, or based on detected or predicted asset risks. Device interface component 208 can be configured to interface with industrial devices or assets on the plant floor, either directly or via a gateway or edge device, and receive real-time operational and status data from these assets for the purposes of asset health monitoring and analysis.

Monitoring component 210 can be configured to monitor specified sets of the collected industrial data for conditions indicative of a performance issue requiring investigation or maintenance. In some embodiments, the sets of industrial data to be monitored, as well as the conditions of this data that indicate a performance concern that requires a maintenance task to be scheduled, can be determined or defined by the system 202 based on analysis of the assets'performance over time, can be manually configured by an administrator of the system 202, or can be defined by asset profiles created by the system 202.

Analysis component 212 can be configured to generate maintenance guidance information or recommendations in connection with performing a maintenance task based on analysis of any of open or closed work order data, real-time and historical asset performance data, or asset information maintained by the asset profiles.

Device management component 214 can be configured to generate and maintain asset management data for the customer's collection of industrial assets. This asset management data can comprise asset profiles representing the respective industrial assets or devices, as well as functional relationships between these assets. A customer-specific asset profile can comprise a basic asset profile corresponding to the asset's type which has been configured to capture the customer's specific asset configuration. Asset profiles can be organized according to an asset hierarchy that defines relationships between primary assets and their sub-components. The system 202 can use this organized asset data in connection with providing customized asset management information and services. In some embodiments, the device management component 214 can discover new industrial assets deployed within the industrial facility based on analysis of the industrial data monitored by the monitoring component 210, and can automatically create and classify asset profiles for these newly discovered assets.

The one or more processors 220 can perform one or more of the functions described herein with reference to the systems and/or methods disclosed. Memory 224 can be a computer-readable storage medium that stores computer-executable instructions and/or information for performing the functions described herein with reference to the systems and/or methods disclosed. Memory 224 can also store work order data submitted by users as work orders 222.

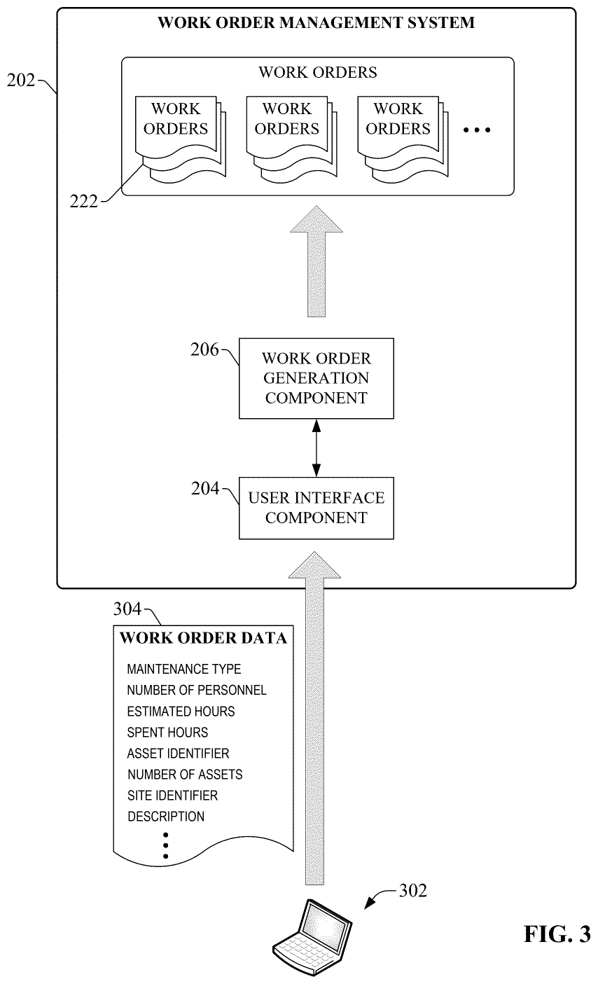

FIG. 3 is a diagram illustrating generation of work orders 222 using the work order management system 202 according to one or more embodiments. Work order management system 202 can be implemented on any suitable platform that allows the system 202 to be accessed via client devices 302 (e.g., desktop computers, laptop computers, smart phones, tablet computers, wearable computing devices, etc.). For example, system 202 can be installed and executed on an on-premise server device on a plant or office network of an industrial facility. Alternatively, system 202 can be executed on a cloud platform as a set of cloud-based services, allowing users at different industrial facilities to access the system 202 and initiate work orders 222, view work orders 222, or receive maintenance guidance from the system 202. System 202 can also be executed on a public network such as the internet and made accessible to users having suitable authorization credentials. In such embodiments, the system 202 can maintain work orders 222 for different industrial enterprises in a segregated manner, such that employees of a given industrial enterprise can only access work orders and associated analysis results associated with that enterprise.

The user interface component 204 can allow client devices 302 to communicatively interface with the work order management system 202 and submit work order data 304. This work order data 304 can represent either a newly initiated work order for a maintenance task to be performed, or updated information for an open work order 222 that was previously submitted to the system 202. Substantially any work order format can be supported by various embodiments of work order management system 202. In an example scenario, user interface component 204 can generate and deliver, to the client device 302, user interface displays comprising editable data fields representing features of the maintenance job represented by the work order 222. Items of work order data 304 that can be submitted to the system 202 in this manner can include, but are not limited to, a type of maintenance to be performed, a description of the maintenance, the number of personnel required to perform the maintenance, an estimated number of hours to perform the maintenance, an actual number of hours spent on the job, identities and numbers of industrial assets that are subject to the maintenance, identities of industrial sites or facilities in which the maintenance takes place, materials to be used to perform the job, an expected cost to perform the job (e.g., costs of replacement parts), or other such information.

Embodiments of the work order management system 202 are not limited to submission of work order data 304 via such user interfaces. For example, in some embodiments the system 202 can allow the user to submit work order data 304 as natural language text or speech via a chat interface rendered by the system 202. In such embodiments, the work order generation component 206 can translate this natural language input to corresponding work order data 304 which is then used to populate the content of the relevant work order 222.

Based on submitted work order data 304 describing a reactive or proactive maintenance task to be performed, work order generation component 206 can generate a work order 222 containing information about the maintenance task (or set of tasks) to be performed. The system 202 can classify each work order 222 as either an open work order representing a pending maintenance job to be performed on one or more industrial assets (e.g., machines, production lines, industrial devices, etc.) or a closed work order representing a maintenance job that has been completed.

Creation of work orders 222 via manual submission of work order data 304 by plant personnel, as illustrated in FIG. 3, can be suitable for initiating work orders 222 for reactive maintenance tasks, in which the maintenance tasks are intended to address an unexpected asset performance problem or risk condition. Additionally or alternatively, some embodiments of the work order management system 202 can generate some types of work orders 222 automatically according to a defined maintenance schedule. For example, the work order generation component 206 can be configured to automatically generate and schedule work orders 222 for proactive or scheduled maintenance tasks designed to prolong an industrial asset's lifecycle or to proactively prevent asset failures or performance inefficiencies. These proactive maintenance actions can include, for example, oil changes, inspection routines, proactive replacement of parts at regular intervals, or other such scheduled maintenance tasks. The system 202 can generate and schedule these proactive work orders 222 at regular or semi-regular intervals according to a defined frequency at which the maintenance is to be conducted.

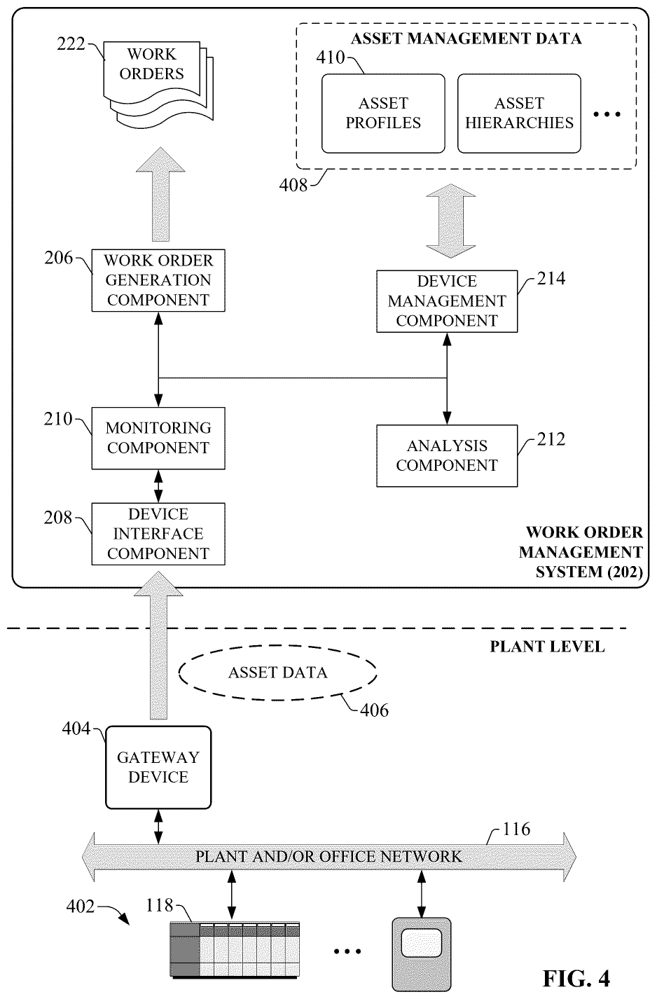

Also, some embodiments of the system 202 can automatically generate reactive work orders 222 in response to real-time detection of an asset performance issue. FIG. 4 is a diagram illustrating an example architecture for automatically generating work orders 222 based on analysis of real-time or historical industrial asset performance. In the example architecture of FIG. 4, a gateway device 404 resides on the same plant network 116 as the industrial devices 402 associated with automation systems on the plant floor. These industrial devices 402 can include, for example, industrial controllers 118, motor drives, HMI terminals, telemetry devices (e.g., flow meters, pressure meters, temperature meters, etc.), sensors of various types (e.g., photo-sensors, proximity sensors, etc.), or other such devices. The automation systems and their associated industrial devices 402, machines, and machine components constitute industrial assets for which reactive or proactive maintenance may be scheduled as needed. During operation of the plant's automation systems, gateway device 404 collects asset data 406 from industrial devices 402. This data can include data values read from data tags, data registers, or automation objects defined on one or more industrial controllers 118; data from analog or digital sensors; data from telemetry devices or meters; or other such data. In general, asset data 406 represents status, operational, or performance data for the industrial assets.

In some embodiments, gateway device 404 can contextualize the collected data 406 prior to delivering the data to the work order management system 202 and deliver the processed data to the system 202 as contextualized data. This contextualization can include time-stamping the data, as well as normalizing or otherwise formatting the collected data for analysis by the work order management system 202. In general, gateway device 404 serves as an edge device that interfaces data from the set of industrial devices 402 to either the work order management system 202 or a separate data storage platform accessible to the work order management system 202.

The work order management system's device interface component 208 can remotely interface with the gateway device 404 to receive the collected asset data 406, and the system's monitoring component 210 can monitor the asset data 406 for conditions indicative of a possible performance issue that necessitates a maintenance action and creation of a corresponding work order 222. In some embodiments, rather than obtaining asset data 406 from the industrial assets (e.g., industrial devices 402 and their associated machines or automation systems) via an integrated device interface component 806, the system's monitoring component 210 may access other sources of real-time or historical asset data 406 generated by the industrial assets within the plant facility, such as a data historian system, a data lake, or other such systems. Robots can also be used to provide at least some of the asset data 406, which can be used by the system 202 in connection with identifying asset performance issues and generating work orders. For example, inspection robots can traverse inspection routes and collect machine states (e.g., via infrared panel scans, meter readings, etc.) and feed this information to the work order management system 202 as asset data 406.

When the monitoring component 210, assisted by the analysis component 212, determines that the monitored asset data 406 satisfies a condition indicative of a current or predicted asset performance issue requiring investigation or correction by maintenance personnel, system's work order generation component 206 can schedule one or more maintenance tasks predicted to correct the performance issue and generate a corresponding work order 222 for the tasks. The condition detected by the monitoring component 210 that triggers creation of a work order 222 can be, for example, a deviation of one or more data tag values that move outside a defined range of normal or expected values, or a deviation of a trend of these data tag values from a learned trend indicative of normal or acceptable asset performance.

In an example scenario, a baking process may require an oven temperature to stay within a defined temperature range. Accordingly, values of a data tag or automation object corresponding to this oven temperature can be collected from the industrial controller 118 that monitors and controls the baking process, and this collected data can be provided to the work order management system 202 as part of the asset data 406. The monitoring component 210 can monitor this value to determine when the oven temperature deviates from this range and, in response to detecting such a deviation, instruct work order generation component 206 to generate a new open work order 222 for investigation of the temperature control issue. In some embodiments, machine-specific asset models maintained on the work order management system 202 can define which data items or performance parameters of the industrial assets are to be monitored, as well as the conditions of this data that are to trigger creation of work orders 222. In other embodiments, the analysis component 212 can learn to recognize conditions of the asset data indicative of an elevated risk to an asset using machine learning, AI, generative AI, or other analytic techniques.

A work order 222 generated by the work order generation component 206 can contain information about the maintenance task to be performed, including but not limited to an identity of the industrial asset or machine for which maintenance is required, an aspect of the industrial asset that requires attention, a type of the maintenance to be performed, an estimated number of hours to be spent on the maintenance task, an estimated number of personnel to be assigned to the task, a description of the task, or other such information. The work order 222 is initially scheduled in the system 202 as an open work order 222 (that is, the system 202 stores the work order 222 as work order data in memory 224 and assigns an “Open” status to the work order 222) and remains open until completion of its associated maintenance tasks, at which time the system 202 assigns a “Closed”status to the work order 222.

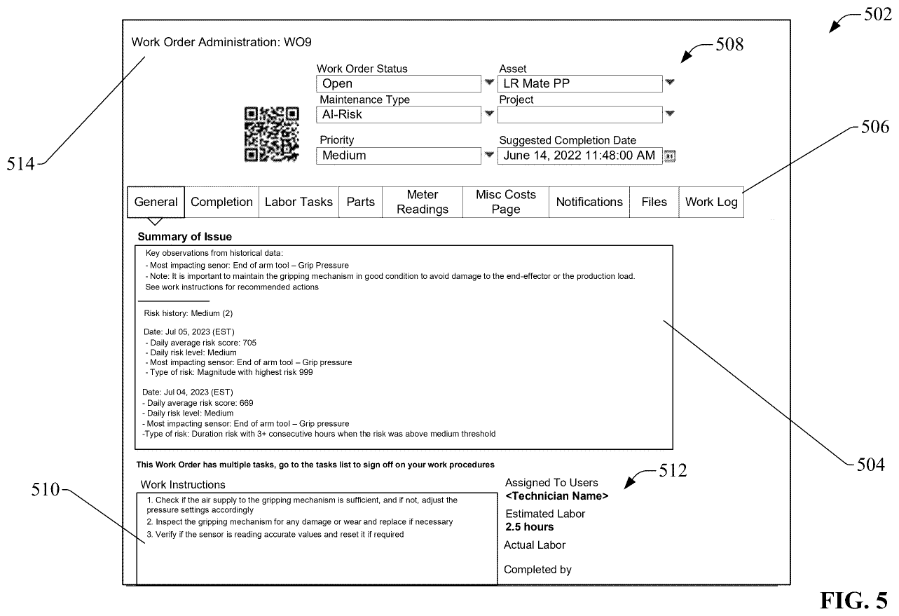

Authorized users can browse and view both open and closed work orders 222 via user interface component 204. FIG. 5 is an example work order display 502 that can be rendered on a client device by the user interface component 204. When a user selects a work order 222 via interaction with the work order system's primary user interface, the user interface component 204 can render a work order display 502 and populate the display 502 with information about the work order. In the example depicted in FIG. 5, the work order display 502 comprises a work order identifier 414 that uniquely identifies the selected work order 222, a section 508 that displays general information about the work order 222 (e.g. the open or closed status, a type of maintenance to be performed, a priority, an identity of the asset on which the maintenance task is to be performed, a suggested completion date for the maintenance, a name of a project with which the maintenance task is associated, etc.), and a navigation bar 506 comprising selectable controls corresponding to respective different categories of additional information that can be viewed.

In the illustrated example, the user has selected the General category from the navigation bar 506, which causes the work order display 502 to render a Summary box 504 containing summary information about the maintenance task, including a description of the asset performance issue or risk to be mitigated by the maintenance task, relevant key observations about the asset, risk information for the asset (e.g., a daily average risk score or a risk level), or other such information. The display 502 also renders an Instructions box 510 that displays instructions for performing the maintenance task, and a section 512 that displays miscellaneous additional information (e.g., identities of the technicians assigned to perform the maintenance task, an estimated number of hours for performing the task, the actual number of hours that were required to perform the tasks, or other such information.

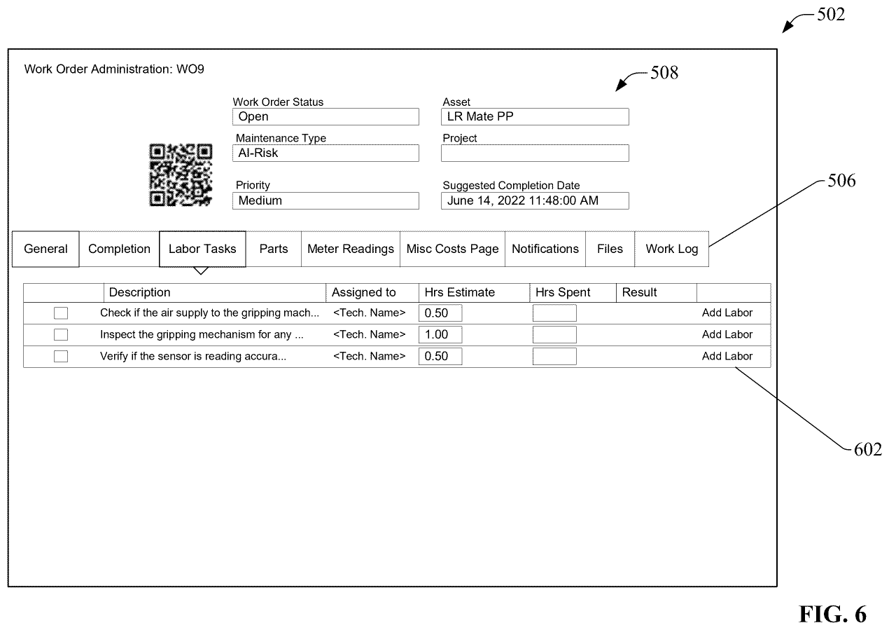

FIG. 6 is another example view of the work order display 502 in which the user has selected the Labor Tasks category from the navigation bar 506, which causes the display 502 to render the individual maintenance tasks defined by the work order 222 as a formatted list 602. Each entry of the list 602 represents a task to be performed, and includes a description of the task, an identity of a maintenance technician to whom the task is assigned, fields for the estimated and actual number of hours spent on the task, a result of the task, and an interactive checkbox control for indicating that the task has been completed.

Returning to FIG. 4, to support intelligent maintenance scheduling, maintenance guidance, and work order generation, some embodiments of the work order management system 202 can automatically identify previously unregistered industrial assets that are in service at the customer's facility and register these assets as asset management data 408. To this end, the system 202 can include a device management component 214 that identifies new industrial assets or devices based on receipt of characteristic asset data 406 from these assets, or using a crawler or other identification means, and creates asset profiles 410 for these assets.

In the example illustrated in FIG. 4, the device management component 214 identifies new and previously unregistered industrial assets or device based on asset data 406 received from these new assets. In an example scenario, the customer may commission a new automation system or machine on the plant floor. As part of this commissioning, industrial devices that make up the new system - e.g., industrial controllers, sensors, motor drives, smart devices, etc. - can begin providing the asset data 406 to the system 202. This data 406 can include information about the asset or device, such as a vendor and model number of the asset, a type of the asset (e.g., a controller, a motor drive, a specific type of industrial machine, an HMI, etc.), or other such characteristic information. Upon discovering that a subset of the asset data 406 received from the customer's assets is characteristic of a new asset or device that has not yet been registered with the work order management system 202, the device management component 214 can create an asset profile 410 for the new asset and register this new asset profile 410 as part of the customer's aggregate asset management data 408, which records information about the customer's collection of industrial assets, as will be described in more detail below.

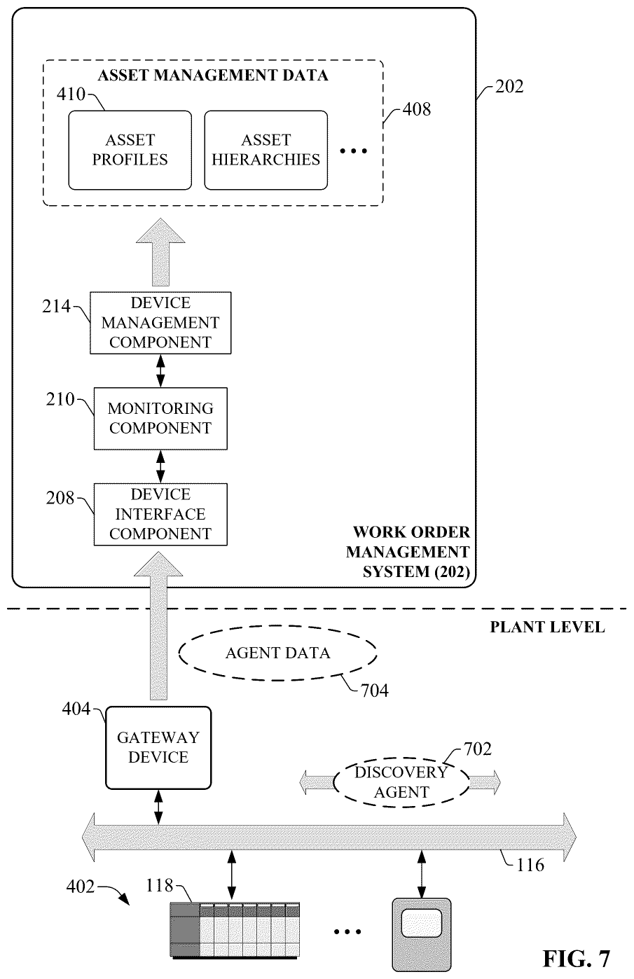

In addition to, or as an alternative to, discovering new industrial assets based on analysis of asset data 406 received from the assets, some embodiments of the work order management system 202 can deploy a crawler on the customer's plant network and use this crawler to discover and report new assets. FIG. 7 is a block diagram illustrating the use of a discovery agent 702 by the system 202 to discover and register industrial assets and devices 402. To this end, the device management component 214 can deploy a discovery agent 702 on the customer's plant network 116, which traverses the network and discovers industrial assets, machines and devices that are in operation within the customer's facility. The discovery agent 702 can return agent data 704 that identifies any newly discovered industrial assets to the work order management system 202. For a given asset, this agent data 704 can include, for example, a vendor and model number of asset, a type of the asset (e.g., a type of device or machine), configuration information for the asset (e.g., configuration parameter settings, network settings, operating modes, etc.), functional or networked relationships between the assets, or other such information. Based on this agent data 704, the device management component 214 creates and registers an asset profile 410. In this way, the work order management system 202 automatically inventories a customer's industrial environment by discovering the industrial assets in use and their associated asset configurations.

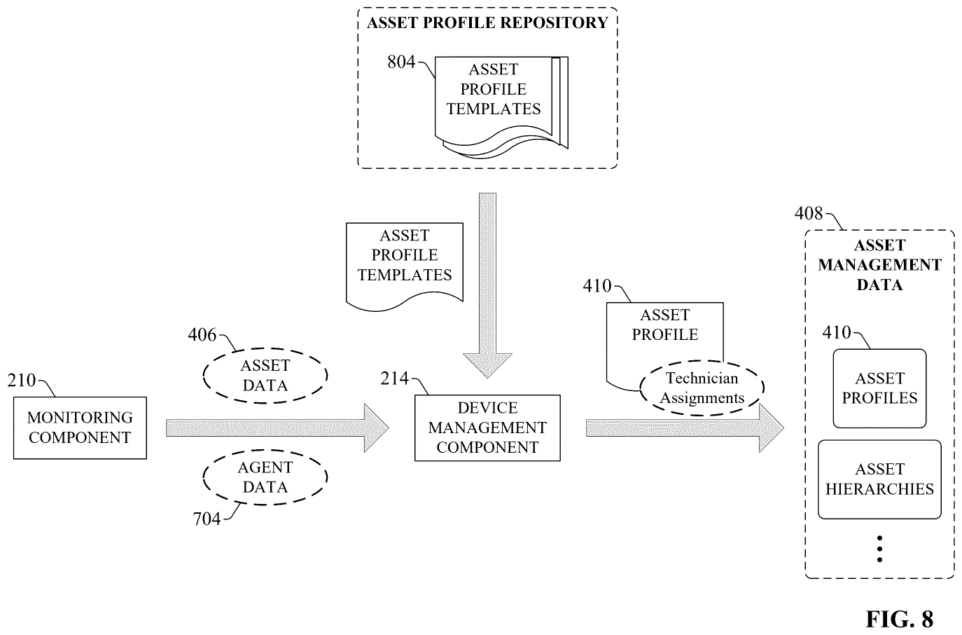

For a given discovered asset, the device management component 214 can create an asset profile 410 based on a basic asset profile template corresponding to the type of the industrial asset, modifying the profile template as needed to record the customer's specific configuration for the asset. FIG. 8 is a diagram illustrating this example approach for creating an asset profile 410. Upon determining that a subset of asset data 406 or agent data 704 reports that a currently unregistered industrial asset is in operation in the customer's facility, the device management component 214 can access a repository of asset profile templates 804 corresponding to respective types of industrial assets, devices, machines, or automations systems, and retrieve one of the asset profile templates 804 corresponding to the type of industrial asset reported by the data 406, 704. The asset profile template 804 can comprise basic information about the asset type, such as identification information for the asset type (e.g., vendor identifiers, model numbers, a description of the type of asset, etc.), a function of the asset, communication ports or I/O associated with the asset, software associated with the asset, or maintenance information that specifies recommended maintenance tasks or strategies for maintaining the asset.

The device management component 214 can modify this basic asst profile template 804 with configuration information specific to the customer's actual asset, as obtained from the asset data 406 or the agent data 704. This configuration information can include, but is not limited to, device parameter settings, communication or network port settings, a current firmware version, software installed on the asset and any associated software configuration settings, hardware settings (e.g., DIP switch settings), or other such configuration information. The device management component 214 can also record the location or production area within the plant facility in which the new asset was discovered (e.g., as reported by the agent data 704). Modification of the asset profile template 804 with this asset-specific configuration information yields an asset profile 410 corresponding to the newly discovered asset. The device management component 214 stores the resulting asset profile 410 as part of the customer's asset management data 408.

Device management component 214 can classify the customer's asset profiles 410 according to any suitable classification schema. This can include organizing the asset profiles 410 according to an asset hierarchy that defines functional or hierarchical relationships between the assets represented by the asset profiles 410. For example, a given asset may be a sub-component of another parent asset (e.g., an I/O module that is installed as part of an industrial controller, an individual machining station that is part of a larger production line or machine, etc.). Accordingly, the device management component 214 can record this hierarchical relationship between the asset and its parent asset as part of asset management data 408. The device management component 214 may also define other types of functional relationship between assets, such as indications of which assets communication with one another, indications of assets that provide parts or materials to other downstream assets, or other such functional relationships. These relationships can either be inferred by the device management component 214 based on asset data 406 or agent data 704, or can be explicitly defined by an end user associated with the customer entity. In this way, the device management component 214 generates a structured tree of asset profiles 410 representing an asset (e.g., an aggregation of sub-assets) or collection of assets and the hierarchical relationships therebetween.

For a given asset profile 410, the system 202 can also record an assignment of technicians who are to be responsible for maintaining the corresponding asset. In some embodiments, the device management component 214 can automatically determine a suitable technician assignment for a given asset profile 410 based on a comparison between technician capabilities, schedules, and designated service locations within the industrial facility (e.g., as determined from stored technician information maintained by the customer) and the type, functionality, and/or location of the asset represented by the asset profile 410. For example, the asset management data 408 may specify the locations of each asset represented by an asset profile 410 within the customer's industrial facility. Based on this information, the device management component 214 can narrow the pool of eligible technicians to be assigned to the asset to those technicians who have been designated to work on assets within that location. The device management component 214 can also determine which subset of technicians have the necessary training, experience, or skills to perform maintenance on the asset given the type of the asset, and automatically assign one or more technicians to the asset on this basis. Alternatively, the work order management system 202 can allow the customer to explicitly assign technicians to the respective asset profiles 410. Technician assignments are recorded as part of the asset management data 408.

To allow the work order management system 202 to provide a rich set of device management services, the device management component 214 can also, for each asset profile 410, access a device or asset knowledgebase maintained by a vendor of the corresponding asset, retrieve asset-specific information relating to the asset, and add this vendor-provided information to the asset profile 410. This vendor-provided information can include, for example, recommended maintenance tasks and schedules for the asset designed to extend the lifecycle or maintain optimal performance of the asset, recommended maintenance countermeasures for addressing specific alarm or performance issues, information regarding sources of spare parts or materials required to perform maintenance tasks on the asset, or other such information.

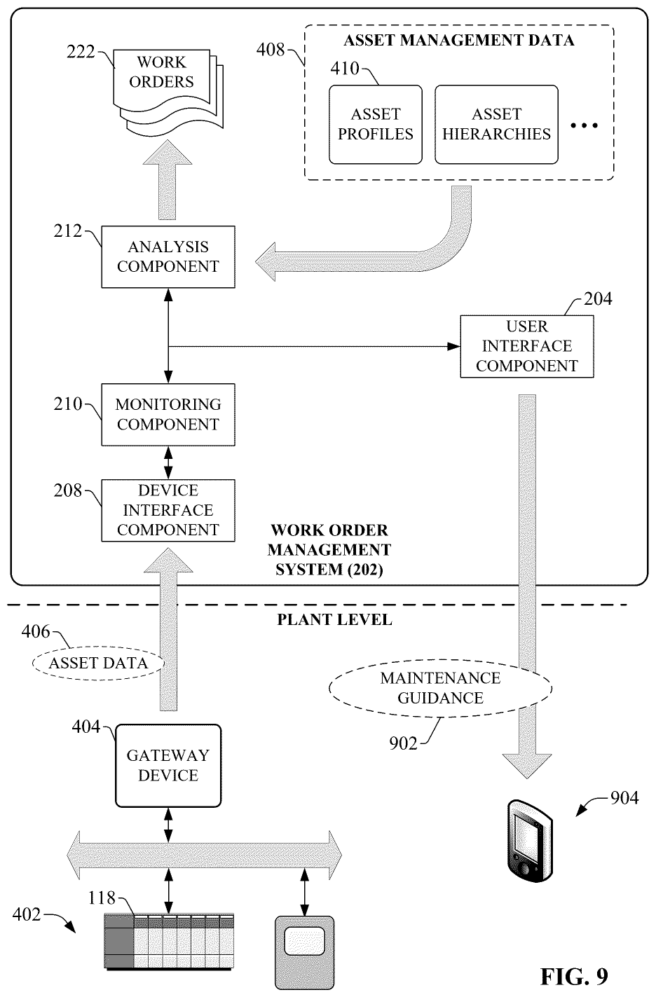

Since the work order management system 202 is a multi-tenant system that provides work order management services for multiple industrial customers, the system 202 tracks and maintains customer-specific asset management data 408 for each customer. For each customer, the system 202 leverages the asset management data 408 for that customer to provide targeted asset maintenance recommendations and guidance, assist with software updates and management, automatically generate and schedule work orders 222 for maintenance tasks, and perform other such asset or device management services. FIG. 9 is a diagram illustrating a general architecture for providing maintenance recommendations and guidance to customers using customer-specific asset management data 408. In general, asset management data 408 inventories and classifies the customer's industrial assets, records configuration information for the assets if appropriate, and encodes defined maintenance knowledge for the respective assets (e.g., recommended scheduled maintenance tasks that should be performed at specified intervals, recommended maintenance countermeasures for respective different alarm or risk conditions, etc.). This maintenance knowledge can be predefined in the asset profile templates 804 from which the asset profiles 410 were generated, and can be maintained and updated by vendors of the respective assets, or by the work order management system 202 itself by accessing asset-specific information in vendor knowledgebases.

Using the asset information encoded as asset management data 408, work order management system 202 can automatically generate work orders 222 for scheduled or proactive maintenance tasks to be performed on the assets. The system 202 can also use this asset management data 408 to generate and deliver maintenance guidance data 902 to client devices 904 associated with the customer entity. For example, the asset profile 410 for a given asset may specify, as part of the profile's encoded maintenance information, that the asset's oil should be changed every two months. Accordingly, the analysis component 212 can learn this recommended scheduled maintenance activity based on analysis of the asset management data 408 and, based on this information, automatically generate and schedule a work order 222 for performing this maintenance task at appropriate intervals. The analysis component 212 can also assign one or more technicians to the work order 222 based on content of the asset's profile 410 (which may specify the pool of technicians who are eligible to work on the asset, as noted above). Other types of scheduled or proactive maintenance activities can be automatically scheduled in this manner based on the maintenance recommendations recorded in the respective asset profiles 410.

In the case of reactive maintenance scheduling, the analysis component 212 can automatically formulate a set of maintenance tasks and generate a corresponding work order 222 in response to detection of an asset performance issue—as determined based on analysis of real-time asset data 406 generated by the customer's assets—using the asset management data 408 as a guide for determining suitable maintenance activities for addressing the issue. For example, as described above in connection with FIG. 4, system's monitoring component 210 can monitor the asset data 406 for conditions indicative of a possible performance issue that necessitates a maintenance action and creation of a corresponding work order 222. The asset profiles 410 that make up asset management data 408 may define normal ranges for key performance indicators for their respective assets, which can be used by the analysis component 212 to determine whether the asset data 406 from a given asset falls outside these normal ranges. The asset profiles 410 may also define abnormal conditions or indicators of asset performance concerns in other ways, such as by defining ranges of multiple key performance indicator values that, if all are satisfied, are indicative of a specific asset performance concern requiring a maintenance countermeasure.

The monitoring component 210 or analysis component 212 can determine whether the monitored asset data 406 is indicative of a performance concern based in part on analysis of the asset management data 408 together with the asset profiles 410, which can define conditions of each asset's asset data 406 that are indicative of a performance issue. For example, the analysis component 212 may determine that values of one or more of the asset's performance indicators deviate from defined normal ranges defined by the corresponding asset profile 410, or that the values of these performance indicators are within a range defined by the asset profile 410 as signifying a particular type of performance issue. In response to determining that the asset data 406 satisfies a condition indicative of a current or predicted asset performance issue (as determined based on the asset management data 408), the analysis component 212 can formulate one or more maintenance tasks for mitigating the performance issue and generate a corresponding work order 222 for the maintenance tasks. The analysis component 212 can reference the asset management data 408 in connection with formulating these maintenance tasks. For example, the asset profile 410 for the affected asset may define a prescribed list of maintenance actions that should be performed to address the detected maintenance issue. Accordingly, the analysis component 212 can generate and schedule a work order 222 for performing these maintenance actions.

In addition to automatically generating work orders 222 in this manner, the work order management system 202 can also generate and deliver proactive maintenance guidance data 902 to client devices 904 of appropriate plant personnel. This maintenance guidance data 902 can be designed to assist in performing maintenance tasks or otherwise maintaining the health and extending the life of the asset. Example maintenance guidance data 902 can include, for example, notifications of newly scheduled work orders 222, notifications of the asset performance issues identified by the system 202 as described above, instructions for performing the prescribed maintenance tasks on the affected asset, recommendations for operating the asset in a manner designed to maximize the life cycle of the asset, notifications of when specific assets are nearing obsolescence, or other such guidance.

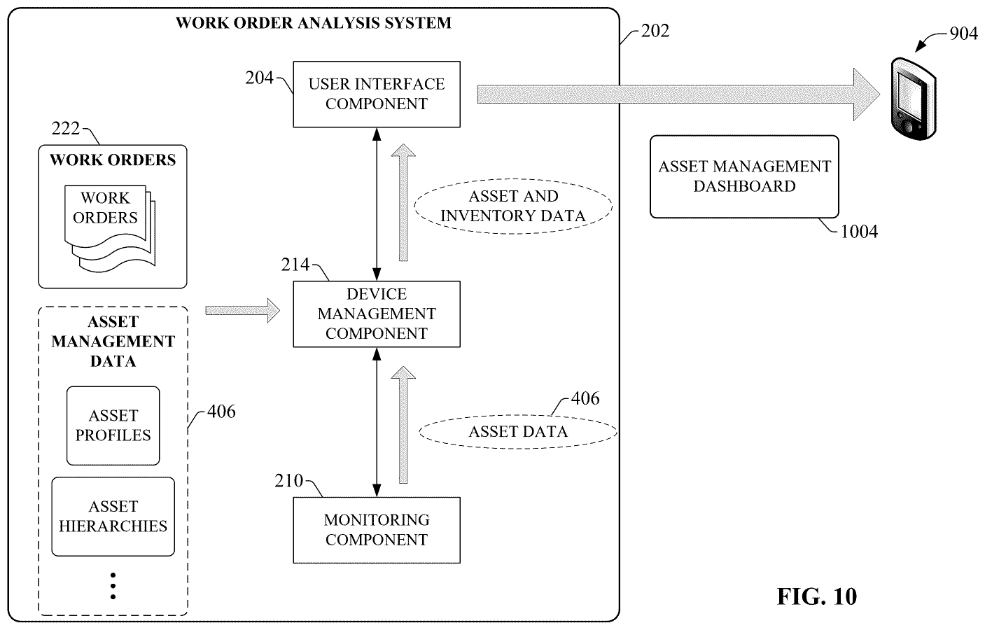

As noted above, the device management component 214 can represent the asset profiles 410 defined by asset management data 408 as a structured tree of asset profiles 410 representing the customer's collection of assets and the hierarchical relationships therebetween. The system's user interface component 204 can visualize this structured tree on an interactive asset management dashboard delivered to the customers'client devices 904. FIG. 10 is a diagram illustrating generation and delivery of an asset management dashboard 1004 to a client device 904. Asset management dashboard 1004 can render an interactive hierarchical graphical representation of the customer's assets based on the asset profiles 410 and hierarchical relationships defined in the asset management data 408. For example, this structured tree can comprise a hierarchical tree of nodes, with each node representing an industrial asset or sub-asset. For assets comprising multiple sub-assets, each represented by a separate asset profile 410, the structured tree can represent the parent asset as a parent node, below which are sub-nodes representing that parent asset's sub-assets.

In some embodiments, the device management component 214 can also render selected information from work orders 222 on the dashboard 1004. For example, in response to selection of an asset from the tree, the dashboard 1004 may render, as an overlay, information regarding any open work orders associated with the selected asset, including the identities of the work orders 222, a list of maintenance tasks prescribed by the work orders 222, a status of each of the maintenance tasks or the work order 222 as a whole, a maintenance history for the asset (e.g., as determined from closed work orders 222 for the asset), or other such information. The dashboard 1004 can also render a graphical map of the customer's industrial assets based on information contained in the asset management data 408.

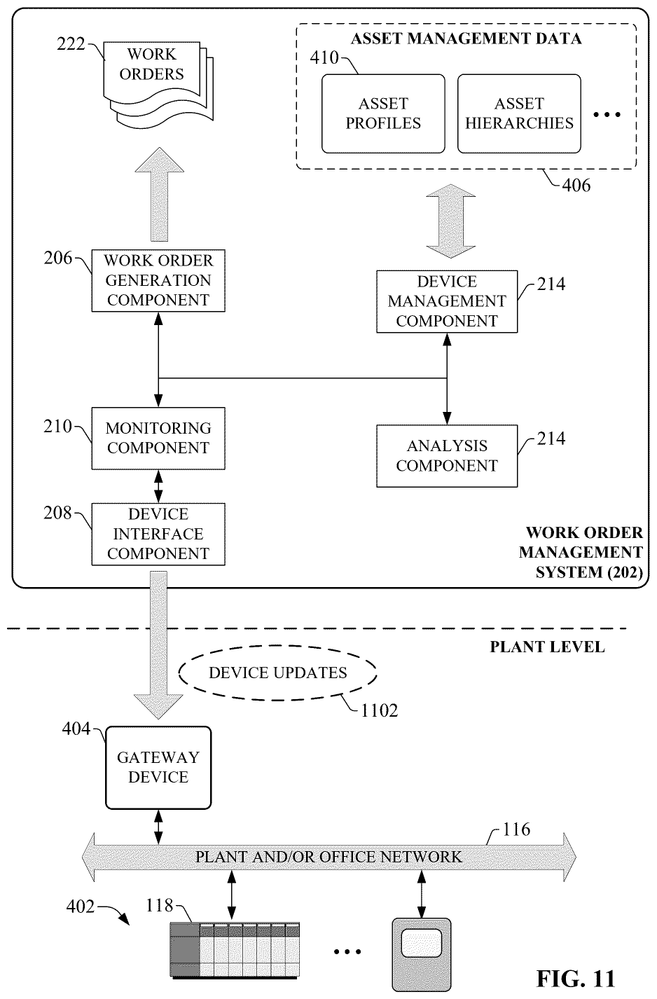

The work order management system 202 can also use asset management data 408 in connection with performing updates to asset software, firmware, or device configurations. FIG. 11 is a diagram illustrating remote configuration of a customer's industrial assets using work order management system 202. As part of the device or asset management services offered by the work order management system 202, the device management component 214 can determine when any of the customer's industrial assets that execute software or firmware require an update, and automatically send any available updated software or firmware to those assets as device updates 1102. In an example architecture, the device management component 214 can access vendor knowledgebases or databases maintained by different industrial device vendors to determine when updated software or firmware for respective types of assets become available. Based on knowledge of the assets that are in use at the customer's facility, as determined from the asset profiles 410 maintained as part of asset management data 408, the device management component 214 can identify which of the customer's assets are eligible for software or firmware updates, retrieve the necessary updates from the vendor's software database or knowledgebase, and instruct the device interface component 208 to send these updates to the appropriate assets as device updates 1102. In some architectures, when the system 202 performs an automated update to a device's software (e.g., a firmware or configuration update), the update 1102 can first be sent to an on-premise control instance that waits for an appropriate time to implement the change on the device (e.g., while the production line on which the device operates is expected to be idle for a minimum amount of time that exceeds the expected time required to install the update 1102). In some embodiments, users can be notified of available software updates via asset management dashboard 1004, and can manually initiate sending of the necessary updates 1102 to selected assets or devices via interaction with the dashboard 1004 (e.g., via interaction with the corresponding asset nodes of the structured asset tree rendered on the dashboard 1004). The system 202 can also support backup-and-restore services for the customer's assets.

In general, work order management system 202 can act as a single point of management for industrial customers'assets and devices. For example, if an industrial device operating in a customer's facility is replaced with a new device, the system's device management services can assist with configuring the replacement devices by retrieving the device configuration information stored in the original asset's asset profile 410 and flashing this device configuration to the new device after the new device has been installed in place of the old device. The device management services can also protect a device's configuration from unauthorized tampering by restoring an approved device configuration (e.g., one stored as part of the device's asset profile 410) back to the device in response to detecting an invalid change to the device's configuration is detected.

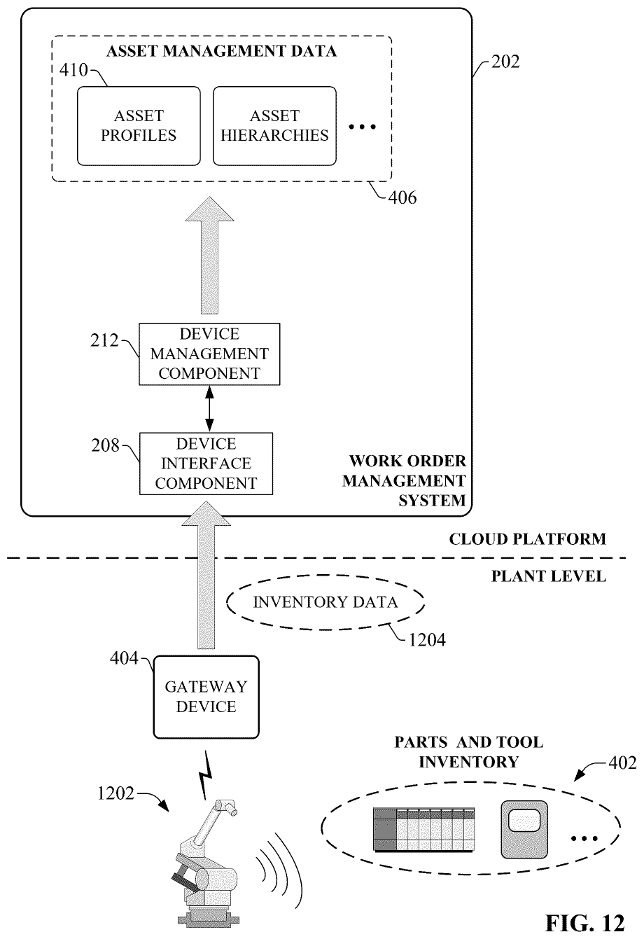

Some embodiments of work order management system 202 can also track and manage spare parts, devices, or other inventory items maintained in the plant facility. FIG. 12 is a diagram illustrating an example architecture for tracking inventories of parts and devices. As part of asset management data 408, the device management component 214 can maintain records of inventory levels of the customer's spare parts (e.g., spare parts or components for industrial assets, spare devices, etc.) as well as the numbers and statuses of tools and equipment used for maintenance activities. To this end, shelves of inventory within the customer's facility can be scanned to identify parts and their locations, and this information can be sent to the system 202 via device interface component 208. Inventory can be scanned manually by plant personnel or by automated mobile robots 1202, as depicted in FIG. 12. Substantially any type of scanning technology can be used to record the identities and locations of parts and inventory, including but not limited to infrared sensors, optical sensors such as time-of-flight sensors, two-dimensional or three-dimensional cameras, near-field or wireless communication interfaces configured to read identification data stored on industrial devices 402, machine vision, radio frequency identification (RFID) tag readers, or other such scanning technologies. In some scenarios, scannable tags or labels can be applied to the customer's spare parts or on the shelves on which those parts are stored, and these scannable tags can be scanned to identify the identities or locations of the parts. In some embodiments, the system 202 can also coordinate inventory verification in a minimally intrusive manner by assigning a user who will be visiting an inventory store room as part of a maintenance task to confirm presence of an inventory item while in the store room.

Upon receiving this scanned inventory data 1204, the device management component 214 can record the identities and locations of the scanned parts as part of asset management data 408; e.g., by creating an asset profile 410 for each discovered part and recording the part's status and location in the profile 410. Parts that are stored in inventory and are not currently in service can be assigned a “spare” or “inactive” status by the system 202. If a scanned part is a component of a larger machine or asset, scanning the part can cause the device management component 214 to populate the asset management data 408 with the identities of other parts known to be associated with the machine. Once recorded as part of asset management data 408, information regarding the customer's inventory of spare parts and equipment can be viewed via asset management dashboard 1004.

The work order management system can automate the process of tracking spare parts consumption to reduce reliance on technicians to log their use. For example, a camera or wearable device carried by a technician can be used to passively discover a previously missing or unaccounted spare part installed on an asset, and based on this discovery the device management component 214 can infer that the part has been consumed and update the asset management data 408 accordingly. Robots 1202 with suitable scanning equipment can also traverse the plant to identify consumed spare parts in this manner.

Embodiments of the work order management system 202 described herein can dynamically maintain up-to-date information regarding an industrial customer's active and spare assets and devices, and offer dynamic and intelligent maintenance guidance based on this asset management information, improving the effectiveness and efficiency of industrial asset maintenance. The system provides this dynamic guidance as an extension of work order management, and thus both tracks the statuses of work orders and proactively facilitates effective execution of the maintenance tasks prescribed by the work orders.

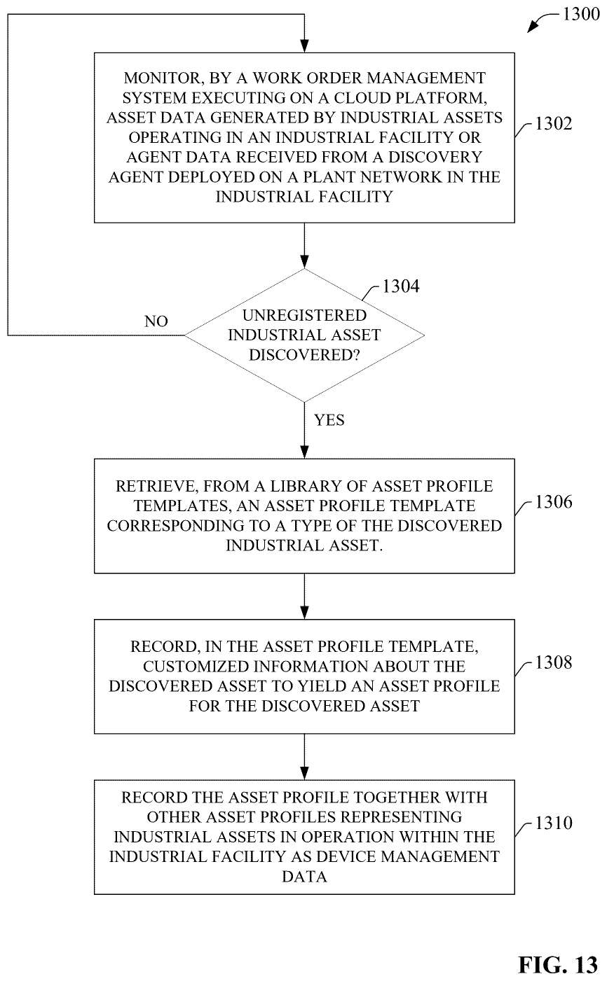

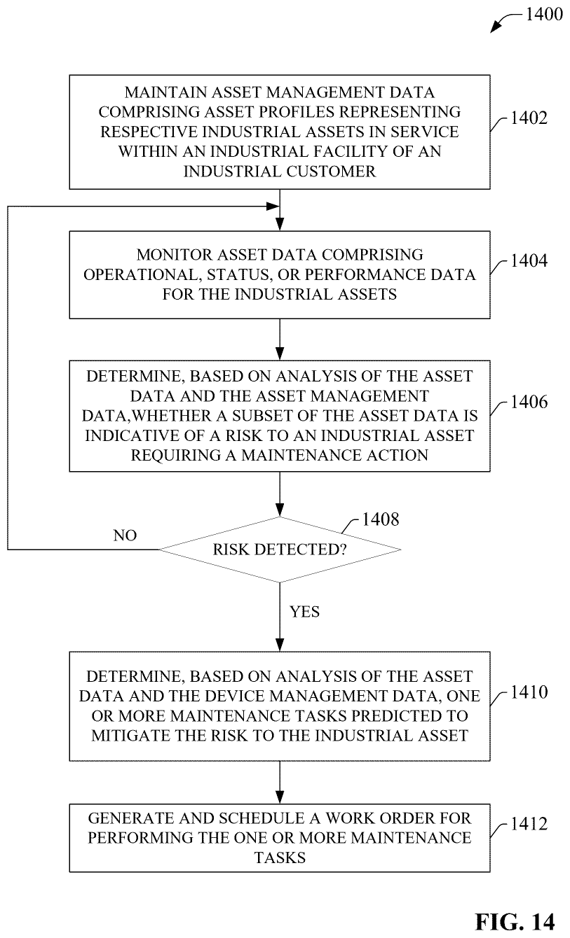

FIGS. 13-14 illustrate example methodologies in accordance with one or more embodiments of the subject application. While, for purposes of simplicity of explanation, the methodologies shown herein is shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 13 illustrates an example methodology 1300 for automatically identifying and recording industrial assets in operation within an industrial facility. Initially at 1302, a work order management system executing on a cloud platform monitors asset data generated by industrial assets operating in an industrial facility, or agent data received from a discovery agent deployed on a plant network in the industrial facility. The asset data can be collected from data tags or automation objects defined on an industrial controller, sensors, telemetry devices, or other industrial devices that monitor or control automation systems in which the industrial assets are used. The collected data represents operational, status, or health information measured for the automation system, and may comprise telemetry values obtained from meters or sensors, status information read from sensors or smart devices (e.g., variable frequency drives), or other such data. The data may be collected by a gateway device that reads the data from the industrial devices and sends the data to a work order management system for monitoring and processing. At least some of this asset data can also be collected by, and a received from, mobile industrial robots capable of obtaining asset status or performance measurements using on-board sensors or data reading capabilities (e.g., near-field communication links, presence sensors, time-of-flight cameras or other types of three-dimensional sensors, heat sensors, etc.). The agent data can be generated and delivered to the work order management system by a discovery agent or other type of software crawler that traverses the plant network and discovers new industrial devices or assets that have not yet been registered by the work order management system.

At 1304, a determination is made, based on a result of the monitoring performed at step 1302, as to whether an industrial asset that has not yet been registered on the work order management is discovered. If no unregistered asset is discovered (NO at step 1304), the methodology returns to step 1302 and the monitoring continues. Alternatively, if an unregistered asset is discovered (YES at step 1304), the methodology proceeds to step 1306, where an asset profile template corresponding to a type of the discovered industrial asset is retrieved from a library of asset profile templates. The asset profile templates can correspond to respective types of industrial assets, devices, machines, or automations systems, and can comprise basic information about the asset type, identification information for the asset type (e.g., vendor identifiers, model numbers, a description of the type of asset, etc.), a function of the asset, communication ports or I/O associated with the asset, software associated with the asset, or maintenance information that specifies recommended maintenance tasks or strategies for maintaining the asset.

At 1308, customized information about the discovered asset is recorded in the asset profile to yield an asset profile for the discovered asset. This customized information can include, for example, device configuration information for the asset, device parameter settings, communication or network port settings, a current firmware version, software installed on the asset and any associated software configuration settings, hardware settings (e.g., DIP switch settings), or other such configuration information. The location or production area within the plant facility in which the new asset was discovered can also be recorded in the asset profile.

At 1310, the asset profile is recorded together with other asset profiles representing industrial assets that are operating within the industrial facility as device management data. In some embodiments, this device management data can also define hierarchical or functional relationships between the asset profiles corresponding to similar relationships between the corresponding physical assets. The device management data can be used to generate asset management dashboard views on a client device, such as an interactive hierarchical tree of industrial assets, an asset map depicting the locations of the respective assets, open work orders for the respective assets, or other such dashboard views. The asset management data can also be used by the work order management system in connection with identifying asset risk conditions, formulating maintenance tasks for mitigating these risks, and generating corresponding work orders for these tasks.

FIG. 14 illustrates an example methodology 1400 for dynamically generating and scheduling work orders using asset management data maintained by a work order management system. Initially, at 1402, asset management data is maintained—e.g., on a cloud-based work order management system—comprising asset profiles representing respective industrial assets in service within an industrial facility of an industrial customer. This asset management data can be maintained using methodology 1300 described above in connection with FIG. 13.

At 1404, asset data comprising operational, status, or performance data generated by industrial assets in service within a plant facility is monitored (similar to step 1302 of methodology 1300). At 1406, a determination is made as to whether a subset of the asset data monitored at step 1404 is indicative of a risk to an industrial asset requiring a maintenance action. In this regard, the work order management system that monitors the asset data can be configured to recognize when one or more of the monitored data values fall outside an expected range suggestive of normal operation of the automation system, or when trends in the monitored data are indicative of a predicted asset failure or performance problem that requires investigation or correction by maintenance personnel. In some embodiments, the system can make this determination based on an analysis of the asset data together with content of the asset management data. For example, some asset profiles maintained as part of the asset management data may define conditions of their respective assets that signify a risk condition or performance concern requiring a maintenance countermeasure. The system can determine, based on the monitoring performed at step 1404, whether a relevant subset of the asset data generated by or retrieved from those assets satisfy the risk conditions defined by the corresponding asset profiles.

At 1408, a determination is made as to whether a risk is detected based on the monitoring and determination steps 1404 and 1408. If no risk is detected (NO at step 1408), the methodology returns to step 1404 and the monitoring continues. If an asset risk is detected (YES at step 1408), the methodology proceeds to step 1410, where the system determines or formulates one or more maintenance tasks that are predicted to mitigate the detected risk. This determination can be based on an analysis of at least one of the asset data itself, information from past work orders (such as past work orders for maintenance that was performed on the asset experiencing the risk conditions), or information contained in the asset management data. For example, in addition to containing information used to identify risk conditions for their corresponding assets, asset profiles may also identify recommended countermeasures for addressing these risk conditions. The formulation of maintenance tasks at step 1410 can be based in part on these recommended countermeasures. At 1412, a work order for performing the one or more maintenance tasks determined at step 1410 is generated and scheduled. At least some content of the work order can be drawn from the asset profile corresponding to the asset on which maintenance is to be performed. As part of the work order generation step 1412, the system can also dynamically prioritize the work order relative to other open work orders, and assign suitable technicians to carry out the work order.

Embodiments, systems, and components described herein, as well as control systems and automation environments in which various aspects set forth in the subject specification can be carried out, can include computer or network components such as servers, clients, programmable logic controllers (PLCs), automation controllers, communications modules, mobile computers, on-board computers for mobile vehicles, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, safety networks, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

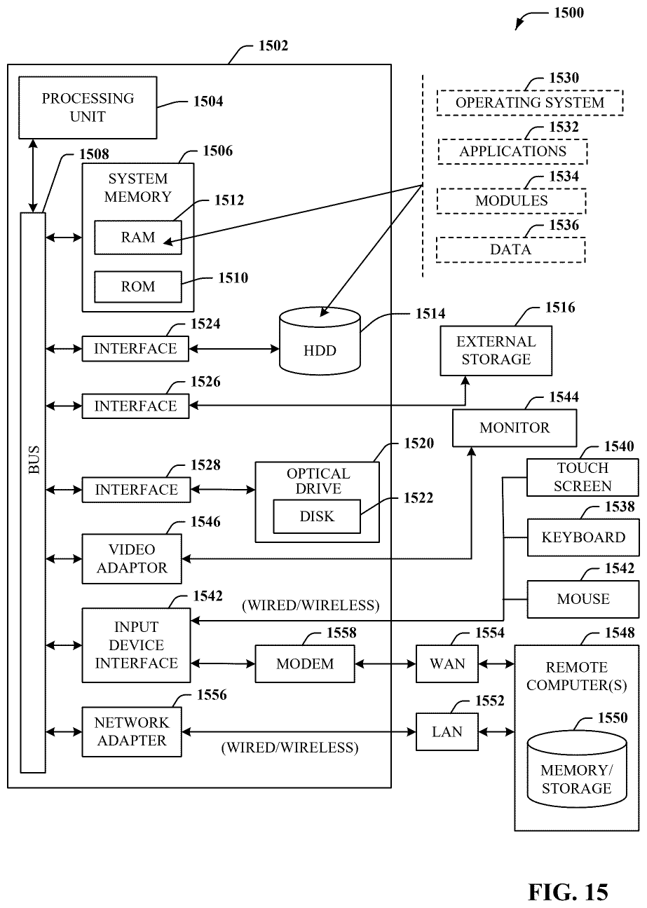

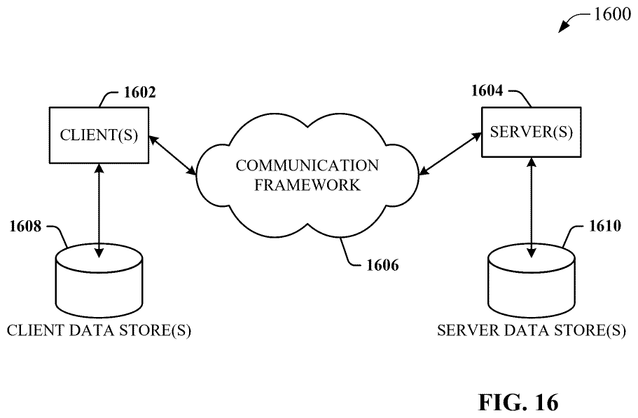

In order to provide a context for the various aspects of the disclosed subject matter, FIGS. 15 and 16 as well as the following discussion are intended to provide a brief, general description of a suitable environment in which the various aspects of the disclosed subject matter may be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 15 the example environment 1500 for implementing various embodiments of the aspects described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and an optical disk drive 1520 (e.g., which can read or write from a CD-ROM disc, a DVD, a BD, etc.). While the internal HDD 1514 is illustrated as located within the computer 1502, the internal HDD 1514 can also be configured for external use in a suitable chassis (not shown). Additionally, while not shown in environment 1500, a solid state drive (SSD) could be used in addition to, or in place of, an HDD 1514. The HDD 1514, external storage device(s) 1516 and optical disk drive 1520 can be connected to the system bus 1508 by an HDD interface 1524, an external storage interface 1526 and an optical drive interface 1528, respectively. The interface 1524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the. NET framework, for application programs 1532. Runtime environments are consistent execution environments that allow application programs 1532 to run on any operating system that includes the runtime environment. Similarly, operating system 1530 can support containers, and application programs 1532 can be in the form of containers, which are lightweight, standalone, executable packages of software that include, e.g., code, runtime, system tools, system libraries and settings for an application.

Further, computer 1502 can be enable with a security module, such as a trusted processing module (TPM). For instance with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1544 or other type of display device can be also connected to the system bus 1508 via an interface, such as a video adapter 1546. In addition to the monitor 1544, a computer typically includes other peripheral output devices (not shown), such as speakers, printers, etc.

The computer 1502 can operate in a networked environment using logical connections via wired and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wired/wireless connectivity to a local area network (LAN) 1552 and/or larger networks, e.g., a wide area network (WAN) 1554. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1552 through a wired and/or wireless communication network interface or adapter 1556. The adapter 1556 can facilitate wired or wireless communication to the LAN 1552, which can also include a wireless access point (AP) disposed thereon for communicating with the adapter 1556 in a wireless mode.

When used in a WAN networking environment, the computer 1502 can include a modem 1558 or can be connected to a communications server on the WAN 1554 via other means for establishing communications over the WAN 1554, such as by way of the Internet. The modem 1558, which can be internal or external and a wired or wireless device, can be connected to the system bus 1508 via the input device interface 1542. In a networked environment, program modules depicted relative to the computer 1502 or portions thereof, can be stored in the remote memory/storage device 1550. It will be appreciated that the network connections shown are example and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1552 or WAN 1554 e.g., by the adapter 1556 or modem 1558, respectively. Upon connecting the computer 1502 to an associated cloud storage system, the external storage interface 1526 can, with the aid of the adapter 1556 and/or modem 1558, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 16 is a schematic block diagram of a sample computing environment 1600 with which the disclosed subject matter can interact. The sample computing environment 1600 includes one or more client(s) 1602. The client(s) 1602 can be hardware and/or software (e.g., threads, processes, computing devices). The sample computing environment 1600 also includes one or more server(s) 1604. The server(s) 1604 can also be hardware and/or software (e.g., threads, processes, computing devices). The servers 1704 can house threads to perform transformations by employing one or more embodiments as described herein, for example. One possible communication between a client 1602 and servers 1604 can be in the form of a data packet adapted to be transmitted between two or more computer processes. The sample computing environment 1600 includes a communication framework 1606 that can be employed to facilitate communications between the client(s) 1602 and the server(s) 1604. The client(s) 1602 are operably connected to one or more client data store(s) 1608 that can be employed to store information local to the client(s) 1602. Similarly, the server(s) 1604 are operably connected to one or more server data store(s) 1610 that can be employed to store information local to the servers 1604.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. A system, comprising:
a memory that stores executable components and a library of asset profile templates corresponding to respective types of industrial assets; and
a processor, operatively coupled to the memory, that executes the executable components, the executable components comprising:
a monitoring component configured to monitor industrial asset data generated by industrial assets in service within an industrial facility, wherein the industrial asset data comprises operational and status information for the industrial assets;
a device management component configured to, in response to discovery, based on analysis of the industrial asset data, of an industrial asset that is not registered with the system,
retrieve, from the library of asset profile templates, an asset profile template corresponding to a type of the industrial asset,
customize the asset profile template using configuration information obtained from the industrial asset to yield an asset profile for the industrial asset, and
record the asset profile with other asset profiles corresponding to other industrial assets in service within the industrial facility to yield asset management data; and
a work order generation component configured to generate work orders for maintenance to be performed on the industrial assets based on the asset management data.

2. The system of claim 1, wherein the device management component is further configured to determine functional relationships between the industrial asset and the other industrial assets, and to define hierarchical relationships between the asset profile and the other asset profiles based on the functional relationships.

3. The system of claim 2, further comprising a user interface component configured to render, on a client device, an asset management dashboard that renders a structured asset tree comprising nodes representing the industrial asset and the other industrial assets organized in accordance with the hierarchical relationships.

4. The system of claim 1, further comprising an analysis component configured to, in response to a determination, based on analysis of the industrial asset data and the device management data, that a subset of the industrial asset data satisfies a condition indicative of a current or predicted risk to the industrial asset, formulate one or more maintenance tasks predicted to mitigate the current or predicted risk,
wherein the work order generation component is configured to generate a work order for the one or more maintenance tasks.

5. The system of claim 4, wherein the analysis component is configured to determine that the subset of the industrial asset data satisfies the condition based on maintenance information about the industrial asset recorded in the asset profile.

6. The system of claim 4, wherein the analysis component is configured to formulate the one or more maintenance tasks based on maintenance information about the industrial asset recorded in the asset profile.

7. The system of claim 1, wherein
the industrial asset is a first industrial asset,
the asset profile template is a first asset profile template,
the asset profile is a first asset profile, and
the device management component is further configured to
deploy a discovery agent on a plant network on which the industrial assets operate, and
in response to receipt of agent data from the discovery agent identifying a second industrial asset that is not registered with the system,
retrieve, from the library of asset profile templates, a second asset profile template corresponding to a type of the second industrial asset,
customize the second asset profile template using configuration information obtained from the second industrial asset to yield a second asset profile for the second industrial asset, and
record the second asset profile with other asset profiles.

8. The system of claim 1, wherein the device management component is further configured to instruct the work order management component to generate and schedule scheduled work orders for proactive maintenance to be performed on the industrial asset based on recommended maintenance actions recorded in the asset profile.

9. The system of claim 1, wherein the device management component is configured to, in response to determining, based on identities of the industrial assets recorded in the asset management data, that updated software or firmware is available for one of the industrial assets, retrieve the updated software or firmware and send the updated software or firmware to the industrial asset as a device update.

10. The system of claim 1, wherein the device management component is further configured to, in response to detecting that a device configuration of the industrial asset has been modified without authorization, reconfigure the industrial asset using the configuration information recorded in the asset profile.

11. The system of claim 1, wherein the device management component is further configured to, in response to receiving scanned inventory data identifying a scanned part or tool within the plant facility, record an identity or location of the scanned part or tool as part of the asset management data.

12. A method, comprising:
monitoring, by a system comprising a processor, industrial asset data generated by industrial assets in service within an industrial facility, wherein the industrial asset data comprises operational and status information for the industrial assets;
in response to discovering, based on analysis of the industrial asset data, an industrial asset that is not registered with the system:
retrieving, by the system from a library of asset profile templates, an asset profile template corresponding to a type of the industrial asset, wherein the asset profile templates correspond to respective types of industrial assets;
customizing, by the system, the asset profile template using configuration information obtained from the industrial asset to yield an asset profile for the industrial asset; and
recording, by the system, the asset profile with other asset profiles corresponding to other industrial assets in service within the industrial facility to yield asset management data; and
generating, by the system, work orders for maintenance to be performed on the industrial assets based on the asset management data.

13. The method of claim 12, wherein the recording comprises:
determining functional relationships between the industrial asset and the other industrial assets, and
defining, as part of the asset management data, hierarchical relationships between the asset profile and the other asset profiles based on the functional relationships.

14. The method of claim 13, further comprising rendering, by the system on a client device, an asset management dashboard that renders a structured asset tree comprising nodes representing the industrial asset and the other industrial assets organized in accordance with the hierarchical relationships.

15. The method of claim 12, further comprising:
in response to determining, based on analysis of the industrial asset data and the device management data, that a subset of the industrial asset data satisfies a condition indicative of a current or predicted risk to the industrial asset, formulating, by the system, one or more maintenance tasks predicted to mitigate the current or predicted risk; and
generating, by the system, a work order for the one or more maintenance tasks.

16. The method of claim 15, wherein the condition indicative of the current or predicted risk is defined in the asset profile.

17. The method of claim 15, wherein the formulating of the one or more maintenance tasks comprises formulating the one or more maintenance tasks based on maintenance information about the industrial asset recorded in the asset profile.

18. The method of claim 12, further comprising generating, by the system, scheduled work orders for proactive maintenance to be performed on the industrial asset based on recommended maintenance actions recorded in the asset profile.

19. A non-transitory computer-readable medium having stored thereon instructions that, in response to execution, cause a system comprising a processor to perform operations, the operations comprising:
monitoring industrial asset data generated by industrial assets in service within an industrial facility, wherein the industrial asset data comprises operational and status information for the industrial assets;
in response to discovering, based on analysis of the industrial asset data, an industrial asset that is not registered with the system:
retrieving, from a library of asset profile templates, an asset profile template corresponding to a type of the industrial asset, wherein the asset profile templates correspond to respective types of industrial assets;
customizing the asset profile template using configuration information obtained from the industrial asset to yield an asset profile for the industrial asset; and
recording the asset profile with other asset profiles corresponding to other industrial assets in service within the industrial facility to yield asset management data; and
generating work orders for maintenance to be performed on the industrial assets based on the asset management data.

20. The non-transitory computer-readable medium of claim 19, wherein the operations further comprise:
in response to determining, based on analysis of the industrial asset data and the device management data, that a subset of the industrial asset data satisfies a condition indicative of a current or predicted risk to the industrial asset, formulating one or more maintenance tasks predicted to mitigate the current or predicted risk; and
generating a work order for the one or more maintenance tasks,
wherein the condition indicative of the current or predicted risk is defined in the asset profile.
